(19) United States
(12) Patent Application Publication
(10) Pub. No.: US 2009/0323875 A1
(43) Pub. Date: Dec. 31, 2009

(54) Method for Data Synchronization

(75) Inventor: Marcel A. Kossel, Reichenburg (CH)

Correspondence Address: PRTSI, INC, 4661 CARISBROOKE LN, FAIRFAX, VA, 22030, US

(73) Assignee: International Business Machines Corporation, Armonk, NY (US)

(21) Appl. No.: 12/165,309

(22) Filed: Jun. 30, 2008

(51) Int. Cl. H04L 7/00

(52) U.S. Cl. 375/354

(57) ABSTRACT

A method, apparatus, and system for a data synchronizer/serial link receiver that performs the alignment of the sampling clock used to retime asynchronous customer data by the application of a negative delay onto the system clock whereas the value of the applied negative delay is derived from the analysis of a temperature code obtained by a tapped delay line in conjunction with the application of preceding replica delay lines for the in-phase and quadrature clock signals.

### FIELD OF INVENTION

This invention is in the field of a method and apparatus for data communication of asynchronous data from an external source (off chip) to a receiver and performing a synchronization of the data to the clock used by the receiver (on chip or system clock).

### BACKGROUND

Prior art systems either use a phase-rotator approach in conjunction with over sampling or a delay line approach by applying a positive delay onto the data signal.

An example of a prior art data synchronizer is shown in FIG. 1. A serializer captures parallel customer data clocked with an external customer clock TxExt_Clk and aligns the customer data to the internal clock domain of the core transmitter that is based on the clock TxPLL_Clk. To enable a synchronous data transfer between the two clock domains, the transmitter core clock is phase adjusted by an analog phase rotator circuit.

The proposed disclosure of a data synchronizer can, in principle, also be used as a serial link receiver. Thus an example of a prior-art serial link receiver is illustrated in FIG. 2 and discussed below to point out how the proposed disclosure differentiates from that prior art. The serial link receiver shown in FIG. 2 is a bang-bang type of link receiver that uses a multiphase signal to acquire a number of data and edge samples whose statistics is then analyzed in the clock-data-recovery (CDR) unit to determine the optimum sampling point of time. As a result of this sample analysis the CDR unit adjusts the phase of the phase rotator such that the receiver samples the incoming data at the optimum sampling point of time—e.g. preferably in the middle of the data bit. In this alignment method the clock adjustment is based on a phase rotator that needs a multiphase input signal to perform the required phase shifting and the phase control is based on a closed loop operation. In addition an over sampling of the data signal is required to obtain a sufficiently relevant edge and data sample statistics.

### SUMMARY

An exemplary embodiment of the invention is a method, apparatus, and system for synchronizing a sampling clock onto a received data stream. The exemplary method comprises performing the generation of a temperature code representing the delay difference between a clock signal and an edge of the received data and evaluating the temperature code to align the clock to the data edges by applying a negative delay onto the system clock. This negative delay is then used to offset the aligned clock to optimally sample the received data stream. The temperature code generation is based on an asynchronously resetable tapped delay line where the data edge is propagating through and the most closely succeeding clock edge is used to obtain the temperature code representing the delay difference between the clock and the data signal. The evaluation of the temperature code is performed by using XOR-gates connected to pairs of adjacent bits in the temperature code to determine the 1-to-0 transition which defines how big the delay difference is. Then a negative delay is applied onto the system clock to align the clock to the data signal, wherein the negative delay is inherently generated by branching off a quadrature clock signal from an identical preceding replica delay line whose switches, attached to the tap points, are controlled by the reversed order of XOR outputs. The offsetting of the clock to shift the sampling point of time to the middle of the data bit of a sub-rate data signal is performed by a multiplexed divider chain.

The apparatus used for the synchronization circuit of the exemplary embodiment of the present invention is comprised of an asynchronously resetable tapped delay line used to obtain a temperature code, which indicates how big the delay difference between the edge of the data signal and the most closely succeeding edge of the clock signal is. The apparatus of this exemplary embodiment is further comprised of a plurality of clock-gated double-edge triggered flip flops attached to the taps of the delay line followed by a plurality of XOR-gates to determine the 1-to-0 transition within the temperature code and a plurality of switches attached to the XOR-gate outputs to select the appropriate tap position via controlling in reversed order switches that are attached to a preceding replica delay line driven by the quadrature clock and being followed by an offset generator. The clock includes a clock gating circuit which consists of an AND-gate with a negative feedback from the output of the first tap in the delay line. A negative delay is generated by branching off the taps of a preceding quadrature clock delay line in the reversed order of how the outputs of the XOR-gates evaluating the temperature code are grouped. The offset generator consists of a plurality of multiplexed dividers.

### BRIEF DESCRIPTION OF DRAWINGS

FIG. 1—Prior-art synchronization using a phase rotator loop

FIG. 2—Prior-art serial link receiver using a clock-data-recovery loop where the alignment of the sampling clock is performed based on a statistical analysis of the data and edge sample samples

FIG. 3—Proposed synchronizer based on tapped delay line

FIG. 4—Operation of asynchronous reset

FIG. 5—An example of a rising edge of the data signal propagating through the tapped delay line.

FIG. 6—Illustration of clock gating for the tapped delay line

FIG. 7—An example of a temperature code and the subsequent evaluation thereof

FIG. 8—An example of how a negative delay is produced to align the in-phase clock signal to the data signal and hence also inherently align the quadrature clock to the middle of the data bit.

FIG. 9—Schematic of delay cell with programmable trip-point used to vary the delay.

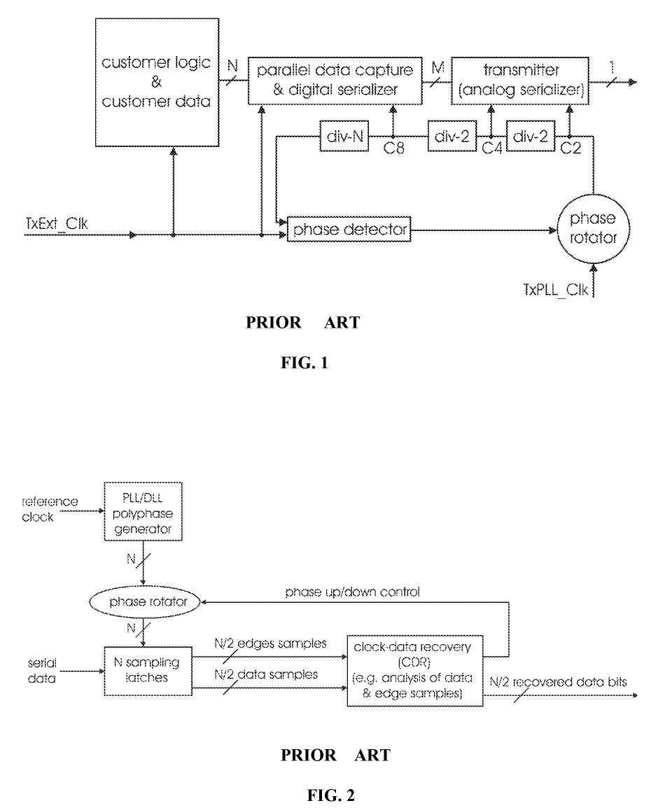

### DETAILED DESCRIPTION OF INVENTION

The proposed method of synchronizing customer data (e.g. at the interface to a link transmitter) or receiving a serial data stream (e.g. within a serial link receiver) is based on a tapped delay line method that provides a temperature code for the phase difference between the data and the system clock. This temperature code is then further processed to apply a negative delay onto the system clock such that it gets correctly aligned to the data via a replica delay line. Once the exact alignment position is known within the replica delay line, alternative sampling clocks can be derived—if needed—by the application of a succeeding offset generator that shifts the sampling clock in time to the desired position—e.g. the middle of the data bit—provided that the sampling frequency is an integer multiple of the data rate. The same principle of synchronizing data can also be applied to a serial link receiver where the proposed method would replace the clock-data-recovery (CDR) unit.

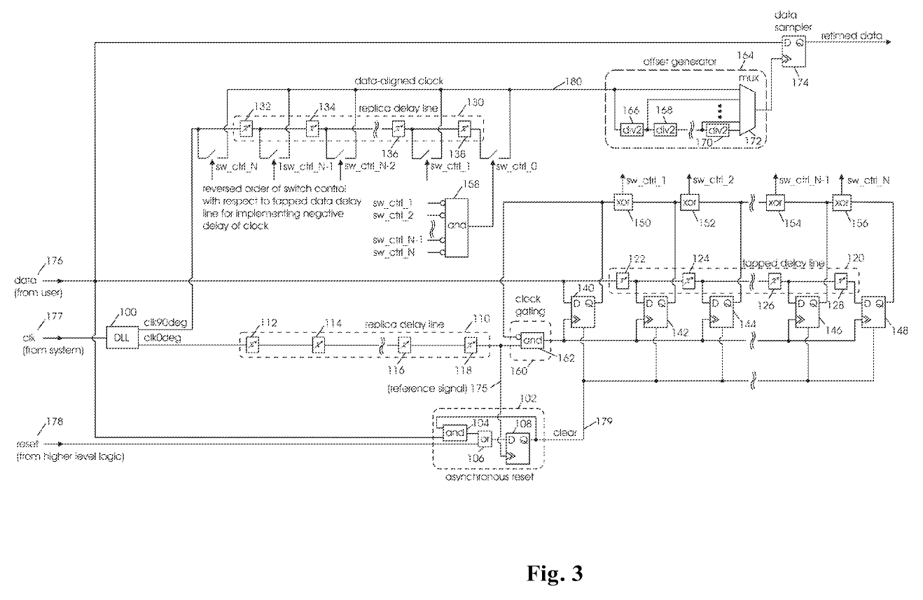

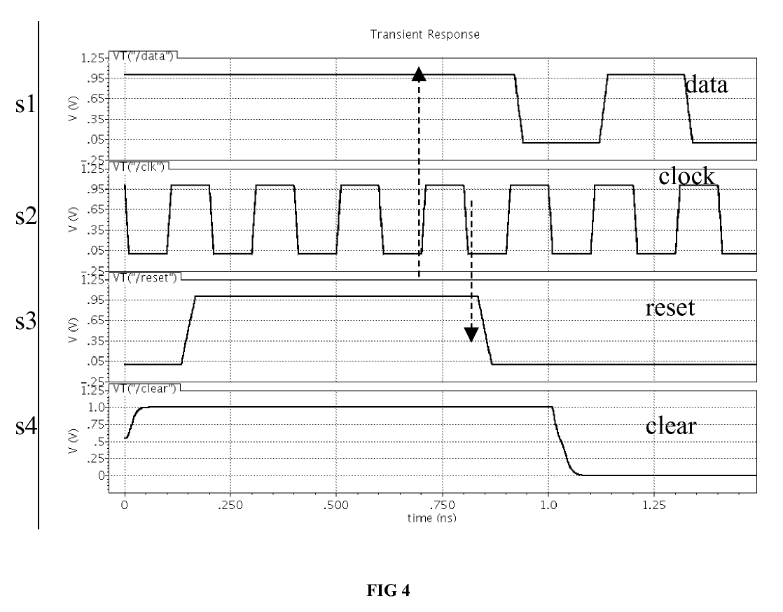

A detailed illustration of the proposed synchronization method is shown in FIG. 3, which will be explained with reference to the timing diagrams shown in FIG. 4-FIG. 8. The system clock 177 is first fed to a delay-locked-loop (DLL) circuit 100 that produces an in-phase clock clk0deg and a 90-degree phase shifted quadrature clock clk90deg. In those cases where an in-phase and a quadrature phase clock are already locally available (e.g. provided by the clock distribution to the synchronizer), the application of a DLL to produce a quadrature clock can be omitted and the existing in-phase and quadrature phase clocks can directly be used for the subsequently described synchronization method.

In order to appropriately use the tapped delay line 120 to generate a temperature code, which indicates how much the clock signal is delayed with respect to the data signal, it first needs to be put into an initial state by an asynchronous reset circuit 102. In that initial state the double-edged triggered D-flip flops 140, 142, 144, 146, 148 attached to the individual delay line outputs get reset by the asynchronous reset circuit 102 consisting of an AND-gate 104, an OR-gate 106 and a double-edge triggered D-flip flop 108. A logical high value of the asynchronous reset signal 178 is fed through the OR-gate 106 to the D-input of the double-edge triggered flip flop 108. Because the flip flop 108 is double edge triggered, it samples the D-input signal at the first rising or falling clock edge occurring after a change of the input signal. This allows for maximally fast resetting the tapped delay line 120 if needed. The clock signal of the flip flop 108 comes from the output of a replica delay line 110 where the in-phase component clk0deg of the clock signal is propagating through. The output of that replica delay line is termed reference signal 175.

Once a logical high level occurs at the output of the D-flip flop 108 in the asynchronous reset circuit 102, this logical high level is held as long as the data signal 176 is logical high. This is important because the tapped delay line 120 would otherwise yield a wrong temperature code, if the falling edge of the incoming reset signal 178 occurs during the period of time where the data signal 176 is logical high because the rising edge that would then start propagating through the tapped delay line 120 would actually come from disabling the reset and not from a valid edge of the data signal. The temperature code would then represent the time difference between the edge of the clock signal and the falling edge of the reset signal instead of measuring how much the clock edge is delayed with respect to the data edge.

To prevent such a wrong operation, the output of the flip flop 108 in the reset generating circuit 102 is fed back to an AND-gate 104 whose second input is the data signal 176. As long as the data signal is high, the logical high output of the AND-gate 104 is fed through the succeeding OR-gate 106 to the D-input of the flip flop 108. Regardless of whether the asynchronous reset signal 178 has already returned to zero, still a logical high value occurs at the output of the flip flop 108 as long as the data signal 176 remains logical high. An example of the operation of the asynchronous reset circuit 102 illustrating the above discussed constellation of the different signals used to produce a valid reset signal 179 (labeled clear) is depicted in FIG. 4. Despite the asynchronous reset (signal s3) going low during the period of time where the data signal (signal s1) is high (up-pointing arrow), the output signal of the asynchronous reset circuit labeled “clear” (signal 4) does not go low until the clock edge (signal s2) coming next after the data signal has assumed a logical zero state (down-pointing arrow).

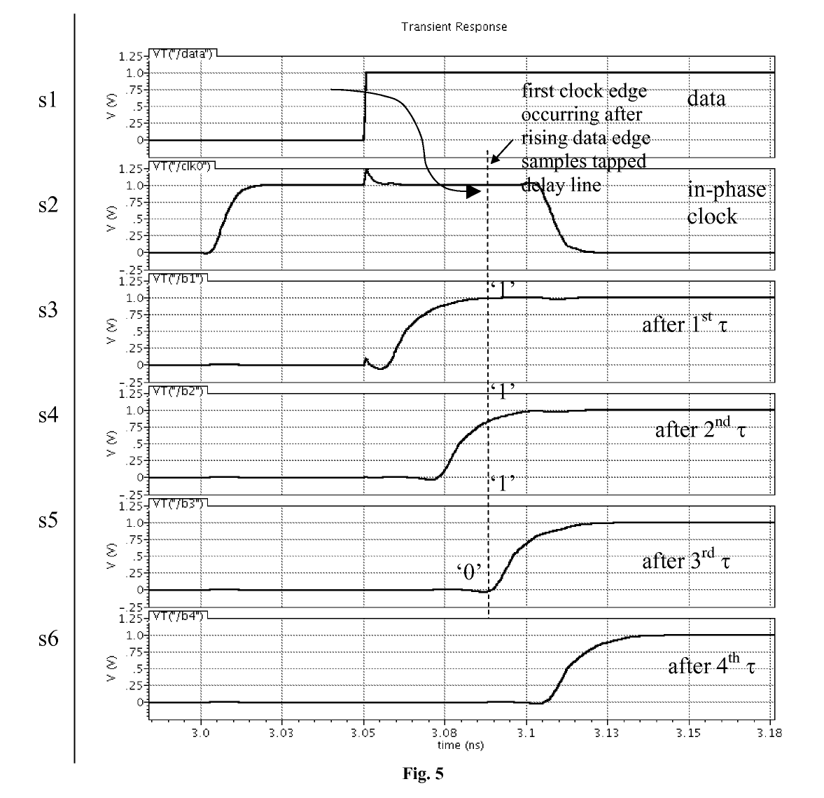

Once the tapped delay line 120 is appropriately reset, an edge of the data signal 176 can start propagating through the delay line 120. An example of a rising edge of the data signal 176 propagating through the tapped delay line 120 is shown in FIG. 5. The rising edge of the data signal (signal s1) propagates through the delay line 120 where the signals s3 through s6 show the outputs of the individual delay cells 122, 124, 126, 128. The first edge of the in-phase clock signal (signal 2) samples the tapped delay line to obtain a temperature code (here: 1110 . . . ) that indicates how big the misalignment is between the clock and the data signal expressed by how many delays, Tau, (here: 3× Tau) the rising edge of the data signal has propagated through until the first clock edge (here: a falling edge) occurs.

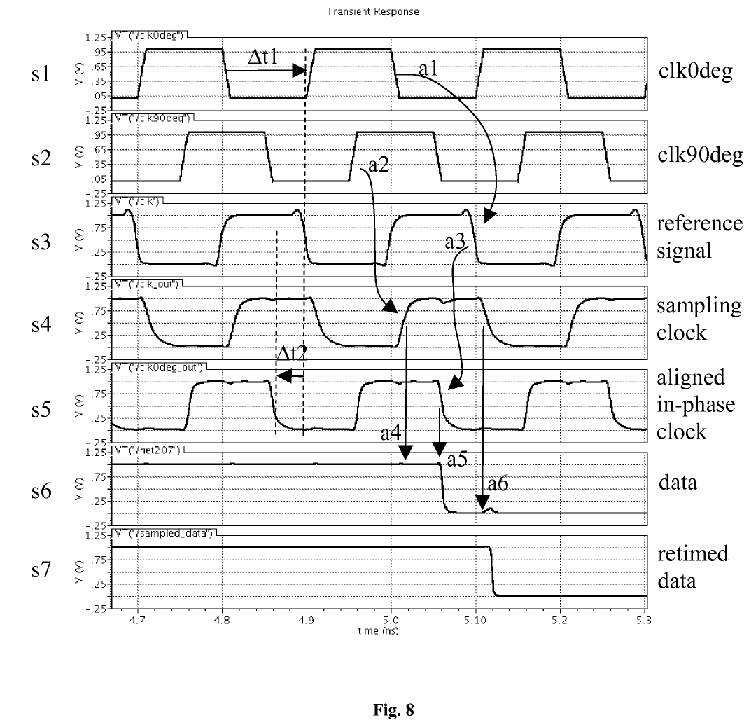

The delay line 120 itself is made of a number of inverters whose delay, through delay cells, 122, 124, 126, and 128 can be varied to more accurately determine the time difference between the edge of the data signal propagating through the delay line 120 and the clock signal. An example of a delay cell where the delay is varied through a variation of the inverter's trip-point is shown in FIG. 8. The in-phase clock signal clk0deg (signal s1) first propagates through the delay line 110 whose output signal (signal s3) is denoted as reference signal and is being used for the alignment of the clock to the data signal (signal s6). The alignment results in a delay, Delta t2, which is negative with respect to the delay, Delta t1 (which equals to half of a clock cycle). Because of the identical delay lines, the quadrature clock signal clk90deg (signal s2) is also inherently delayed by Delta t2 and gets transformed into the final sampling clock signal (signal s4) that samples the data signal at the sampling positions, a4 and a6, to finally result in the retimed and aligned data signal (signal 7). The arrow, a5, shows how the in-phase clock s5 (and hence also the quadrature clock s4) are aligned to the data edge (falling edge in signal s6).

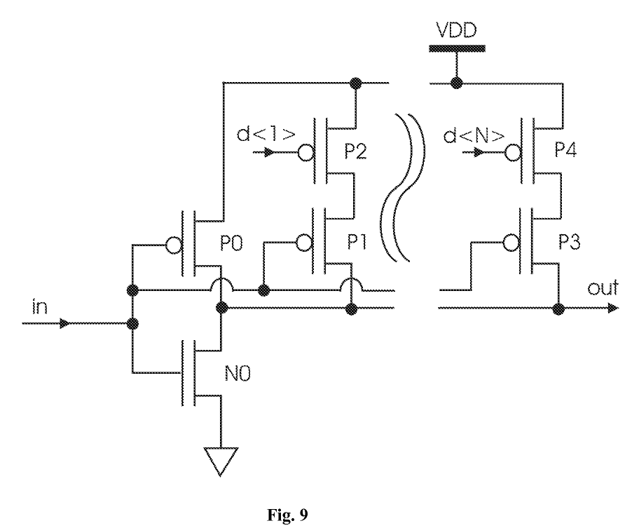

If Tau needs to be varied, it is important that all of the delay cells are varied in the same way so that the individual delays, Tau, through delay cells 122, 124, 126, 128 are always identical with each other. If needed, the delays, Tau, through delay cells 122, 124, 126, 128 can be reduced or increased iteratively until the consecutive 1's in the temperature code get shifted to the left or right. At that delay value setting where a shift within the temperature code occurs, the clock has approached the trip-point of the inverters implementing the delay cells. The location of such a trip-point is the most accurate alignment position that can be attained. A schematic of a delay cell with programmable trip-point used to vary the delay is shown in FIG. 9. The length of the delay line 120 is maximally as long as half of a clock cycle, which means that a potential misalignment between the clock and the data signal is confined to a delay smaller than one half of a clock period.

There are two other delay lines 110, 130 labeled replica delay line where the in-phase clock signal clk0deg and the quadrature clock signal clk90deg are propagating through. Both replica delay lines 110, 130 are exactly identical with the tapped delay line 120 where the data signal 176 is propagating through. If the delays, Tau, through delay cells, 122, 124, 126, 128 in the tapped delay line 120 are changed, all the other delays 112, 114, 116, 118, 132, 134, 136, 138 in the replica delay lines 110, 130 also change in the same way.

The tapped delay line 120, where the edge of the data signal propagates through, gets sampled by the edge of the clock signal just following the edge of the data signal 176. This sampling clock edge might either be a rising or a falling edge because the delay line 120 is tapped by double-edge triggered flip flops 140, 142, 144, 146, 148. Double edge triggered flip flops are used in order to reduce the number of delay cells required by a factor of two because the accumulated delay then only needs to be equivalent to one half of the clock signal period.

It is important to note that the clock sampling the tapped delay line 120 has first propagated through the replica delay line 110 belonging to the in-phase clock signal clk0deg. The output signal 175 of that replica delay line 110 can be regarded as a reference signal defining the reference point of time because the same signal is also used as clock signal for the asynchronous reset circuit 102. With that point of view the delays through delay cells 112, 114, 116, 118 within the replica delay line 110 and also those of the other replica delay line 130 can be considered as being negative delays with respect to the previously defined reference point of time.

The operation of the asynchronous reset circuit guarantees that (a) all Q-outputs of the double-edge triggered flip flops 122, 124, 126, 128 are logical zero once a rising edge of the data signal occurs and (b) the clock signal always lags the data signal. A leading edge of the clock signal cannot occur because of the periodicity of the clock signal and the confinement of the total amount of delay to half a clock cycle. This effectuates a modulo-operation based on half of the clock signal period and hence the clock edge must always occur after the rising edge of the data signal.

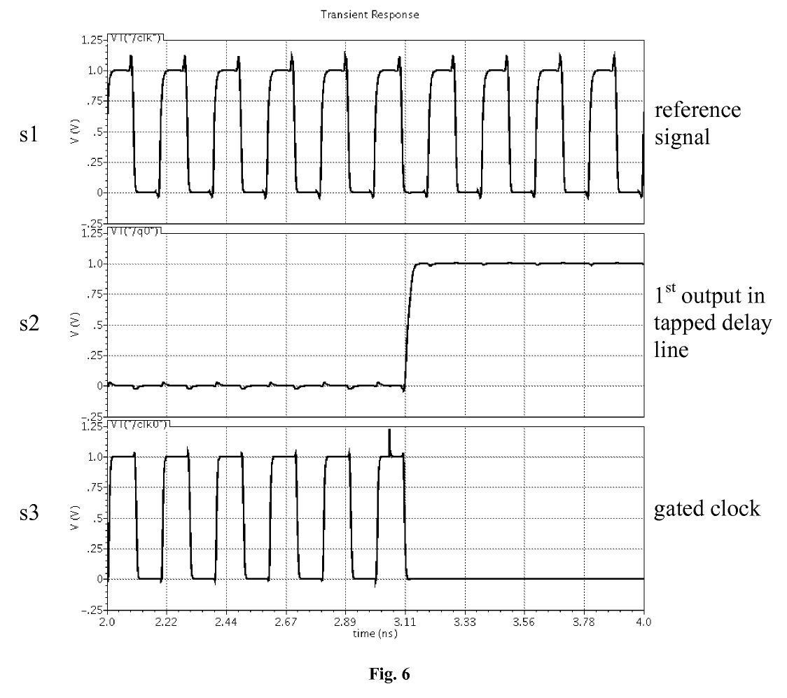

The two circumstances (a) and (b) can be exploited to implement a clock gating 160 for the clock signal triggering the double-edge triggered flip flops 140, 142, 144, 146, 148. Because the Q-output of the double-edge triggered flip flop 140 is forced to assume a logical zero after the flip flop 140 has been put into a reset state, the AND-gate 162 within the clock gating circuit 160 becomes transparent until the fed back Q-output of the flip flop 140 performs a 0-to-1 transition (note that the AND-gate input is inverted). If the Q-output of the flip flop 140 is logical high, the clock signal 175 coming from the replica delay line 110 gets blocked by the clock gating circuit 160. This has the advantage that the Q-outputs of the flip flops 140, 142, 144, 146, 148 remain stable regardless of whether already the next edge of the data signal 176 propagates through the tapped delay line 120. An example of the clock gating operation is shown in FIG. 6. The clock signal s1 (identical to the reference signal 175) occurring at the input of the clock gating circuit 160, gets blocked as soon as the output of the first double-edge triggered flip flop 140 of the tapped delay line 120 assumes a logical high value (signal s2).

At the occurrence of the first rising edge of the data signal 176 after a reset event, each of the delay cell outputs successively perform a 0-to-1 transition according to the data edge that propagates through the delay line 120 (see FIG. 5). The D-inputs of the double-edge triggered flip flops 140, 142, 144, 146, 148 sense the delay cell 122, 124, 126, 128 outputs and make a snapshot of the current state of the delay line 120 as soon as the first clock edge (occurring after the rising data edge) is applied to the clock input of the flip flops 140, 142, 144, 146, 148. Because of the previously discussed operation of the clock gating circuit 160 the snapshot of the delay line's 120 current state—that equals the temperature code—remains unchanged until another reset signal is applied to the flip flops 140, 142, 144, 146, 148 attached to the tapped delay line 120 via the asynchronous reset circuit 102. In the meantime many other edges of the data signal can propagate through the delay line 120 without affecting the obtained temperature code (because of the gated clock signal).

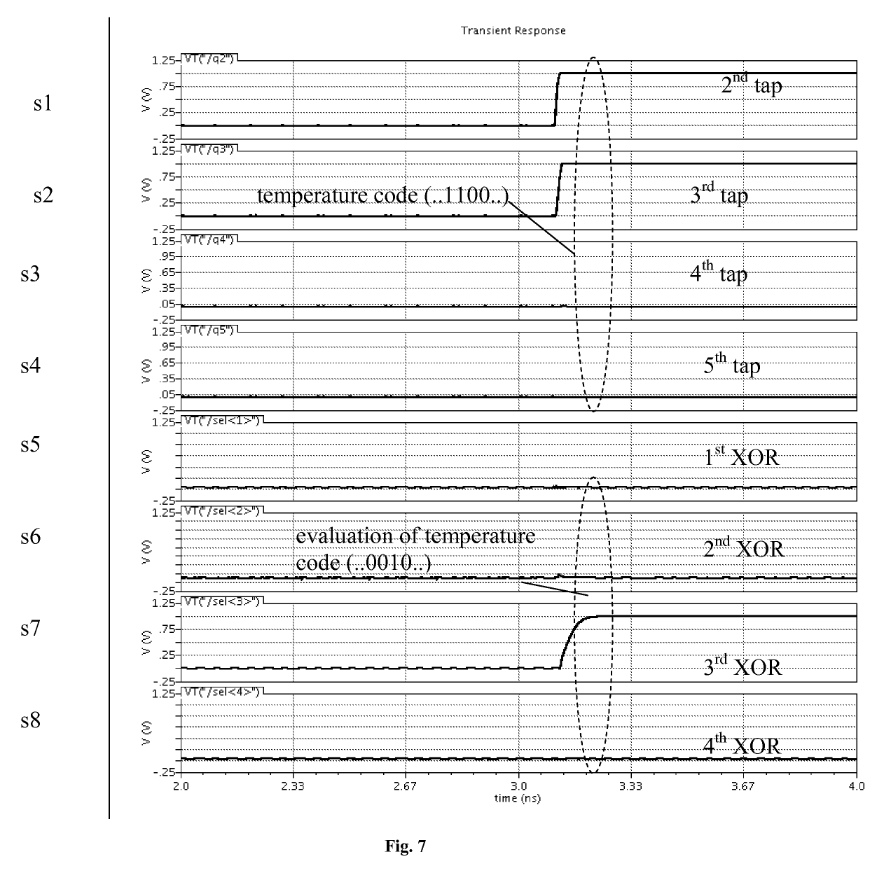

The temperature code is evaluated by the XOR-gates 150, 152, 154, 156 that are connected to the Q-outputs of the double-edge triggered flip flops 140, 142, 144, 146, 148. Each of two adjacent Q-outputs is sensed by an XOR-gate. Because the XOR output is logical zero if the inputs are equal (both either logical zero or logical one), a 1-to-0 transition in the temperature code is indicated by that XOR-gate whose output is logical high because its inputs have different logical values. An example of a temperature code and the subsequent evaluation thereof is given in FIG. 7. The signal s1 through s4 show an excerpt of a temperature code defined by the Q-outputs of the double-edge triggered flip flops 140, 142, 144, 146, 148. The signals s5 through s8 correspond to the outputs of the XOR-gates 150, 152, 154, 156 that evaluate the temperature code in order to determine the location of the 1-to-0 transition. The XOR-gate outputs are used as control signals sw_ctrl_1 through sw_ctrl_N for the switches connected to the individual taps of the replica delay line 130. The control signals are connected in reversed order to the switches to implement a negative delay.

As described above the length of the delay line 120 corresponds to half of a clock cycle and the maximum misalignment between the clock and data signal is smaller than half a clock cycle. Thus the temperature must have either a 1-to-0 transition if the misalignment is larger than one delay, Tau, or the temperature code is zero if the misalignment is smaller than one delay, Tau. An all-1 temperature code can, however, not occur.

If an all-0 temperature code is detected, no clock alignment needs to be performed since the misalignment is smaller than the delay, Tau, which represents the limit (=resolution) of the measurement accuracy. In that case the AND-gate 158 has a logical 1 output (because all inverted inputs are logical one) and the switch associated to the control signal sw_ctrl_0 gets closed so that the output of the delay line 130 is fed to the input of the offset generator 164, which provides the actual sampling clock for the data sampler 174. The signal propagating through the delay line 130 and afterwards being used as sampling clock signal corresponds to the quadrature signal clk90deg. That signal is taken to derive the sampling clock because it samples the data in the middle of a data bit (due to the 90-degree phase shift) once the clock signal is aligned to the data. The basic idea is therefore to use the in-phase clock signal clk0deg for the alignment of the clock signal to the data (and not vice versa!) and the quadrature clock signal clk90deg—that gets inherently aligned to the data via the in-phase clock signal clk0deg owing to the identical replica delay lines 110, 130—for the actual sampling of the data.

If the misalignment between the data and clock signal is larger than the value Tau of a single delay cell and thus the temperature code contains a 1-to-0 transition that is indicated by a logical 1 at the output of one of the XOR-gates 150, 152, 154, 156, the quadrature clock signal will be delayed by a negative delay value corresponding to the measured clock-data delay indicated by the 1-to-0 transition in the temperature code. It is important for the high-speed operation of the synchronizer that the clock signal is negatively delayed and not that the data signal is positively delayed to have both the clock and the data signal being aligned. The reason for this is that the quality (=signal integrity) of the received data signal is much less under the control of the circuit designer than the clock signal and therefore as little data processing (=adding delays) as possible should be applied to the data signal prior to the point of time where it gets sampled.

The addition of a negative delay to the quadrature signal is implicitly performed by connecting the output signals of the XOR-gates—labeled sw_ctrl_1 to sw_ctrl_N—in reversed order to the switches attached to the replica delay line 130 of the quadrature clock signal. Because the replica delay lines 110, 130 are identical and also represent exact copies of the tapped delay line 120, the reversed order of how the XOR-gate outputs are used to control the switch in the replica delay line implicitly adds a negative delay to the quadrature signal because the reference signal was defined as the output signal of the replica delay line 110 where the in-phase clock clk0deg is propagating through. An example of how a negative delay is produced to align the in-phase clock signal to the data signal and hence also inherently align the quadrature clock to the middle of the data bit is given in FIG. 8.

The quadrature sampling clock signal—which is indirectly aligned to the data signal via the in-phase clock—is fed to an offset generator 164 consisting of a chain of dividers 166, 168, 170 whose outputs can be selected by a multiplexer 172 that finally provides the sampling clock for the data sampler 174. The output of the data sampler 174 represents the retimed data. The offset generator assures that the sampling clock actually occurs in the middle of the data bit.

If the data is at full rate and hence has at the same frequency as the sampling clock, the multiplexer 172 is configured such that the divider chain 166, 168, 170 gets bypassed and the input signal 180 of the offset generator 164 is directly fed to the output. On the other hand if the data is transmitted at a sub-rate, e.g. at quarter-rate, the multiplexer 164 selects the output of the second divider 168 to be fed to the output of the offset generator 172 because the data rate is four times slower than the clock frequency and hence the effective sampling point of time must also be displaced by half a quarter rate period in order to still being able to sample the quarter rate data in the middle of the data bit. The data must preferably be sampled in the middle of a data bit because there the probability of getting affected by timing jitter is minimal.

1. A method for synchronizing a sampling clock onto a received data stream, the method comprising:
performing the generation of a temperature code representing the delay difference between a clock signal and an edge of the received data;
evaluating the temperature code,
aligning the clock to the data edges by applying a negative delay onto the system clock; and
offsetting the aligned clock to optimally sample the received data stream.
